(19) United States
(12) Patent Application Publication
(10) Pub. No.: US 2026/0328963 A1
(43) Pub. Date: Oct. 22, 2026

(54) FORWARD MODELING DIFFERENT RESERVOIR REALIZATIONS USING KNOWN CHARGE FLUIDS AND RESERVOIR FLUID GEODYNAMIC PROCESS

(71) Applicant: SCHLUMBERGER TECHNOLGY CORPORATION, Sugar Land, TX (US)

(72) Inventors: Armin KAUERAUF, Aachen (DE); Hadrien DUMONT, Paris (FR); Shu PAN, Calgary (CA); Soraya S. BETANCOURT POCATERRA, Houston, TX (US); Jesus Alberto CANAS, Houston, TX (US); Kang WANG, Houston, TX (US); Olivier c. Mullins, Houston, TX (US)

(21) Appl. No.: 19/111,333

(22) PCT Filed: Sep. 18, 2023
(86) PCT No.: PCT/US2023/032986

§ 371 Date: Mar. 13, 2025

Related U.S. Application Data
(60) Provisional application No. 63/375,869, filed on Sep. 16, 2022.

(51) Int. Cl. G01V 20/00

(52) U.S. Cl. CPC G01V 20/00

(57) ABSTRACT

A method of forward modeling reservoir fluid geodynamics that accounts for both slow processes and fast processes. The method provides a model that accounts for the fluid geodynamics from charge to current time.

### CROSS-REFERENCE TO RELATED APPLICATIONS

The current application claims priority to U.S. Provisional Patent Application 63/375,869, filed Sep. 16, 2022, the entirety of which is incorporated by reference.

### FIELD OF THE DISCLOSURE

Aspects of the disclosure relate to modeling reservoir fluid geodynamics. More specifically, aspects of the disclosure relate to a forward modeling process using known charge fluids and reservoir fluid geodynamic processes.

### BACKGROUND INFORMATION

Characterization of subsurface reservoirs remains a significant challenge due to fundamental limitations in the physics of measurements. One powerful method to identify complexities of any structure is to characterize the formation of the structure over time. Oilfield reservoirs are composed of rock formations and fluids, and both can be considered as structures. The time evolution of each can be characterized with the initial formation of the structure and the subsequent alteration of the structure in geologic time to present day.

For rock formations, this type of analysis, considering depositional setting and post deposition alteration, is performed, at least conceptually, by asset geologists and geophysicists. FIG. 1 illustrates an example of this type of analysis where various rock depositional settings and various post deposition alterations or “structural geodynamics” are depicted. Post deposition alterations are considered when evaluating current day rock formations. The study of structural geodynamics is used in evaluation of the two major types of traps, stratigraphic and structural, of interest in hydrocarbon recovery projects.

In contrast, fluids have not been treated with the same degree of rigor in the hydrocarbon recovery industry. There is a need for a method of modeling that can account for reservoir fluid evaluation or reservoir fluid geodynamics (“RFG”) during and post charge.

There is a further need to be able to accurately predict basins and fields of hydrocarbons more accurately than conventional methods.

There is a further need to be able to be able to predict amounts of hydrocarbons in a reservoir in an economical and quick manner.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one non-limiting embodiment, a method of analyzing a geological stratum including geological structures including both fluids and solids. The method may comprise modeling the geological structures using at least one of diffusion and charge history. The method may also comprise obtaining a final outcome of field conditions. The method may also comprise using such field conditions, determining a presence of at least one fast process in the geological stratum, wherein the fast process is at least one process of biodegradation, local phase change, nanocolloidal settling, spill-fill and localized diffusion.

In another example embodiment, an object of manufacture configured to store a set of instructions configured to be performed on a computer, the object of manufacture having a non-volatile memory, the set of instructions comprising a metho is disclosed. The method steps of the method may comprise modeling the geological structures using at least one of diffusion and charge history and obtaining a final outcome of field conditions. The method may also comprise using such field conditions, determining a presence of at least one fast process in the geological stratum, wherein the fast process is at least one process of biodegradation, local phase change, nanocolloidal settling and localized diffusion.

### BRIEF DESCRIPTION OF THE FIGURES

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are therefore not be considered limiting of its scope, for the disclosure may admit to other equally effective embodiments.

FIG. 1 illustrates rock formations that are analyzed with accounting for consideration of depositional setting and post deposition alterations.

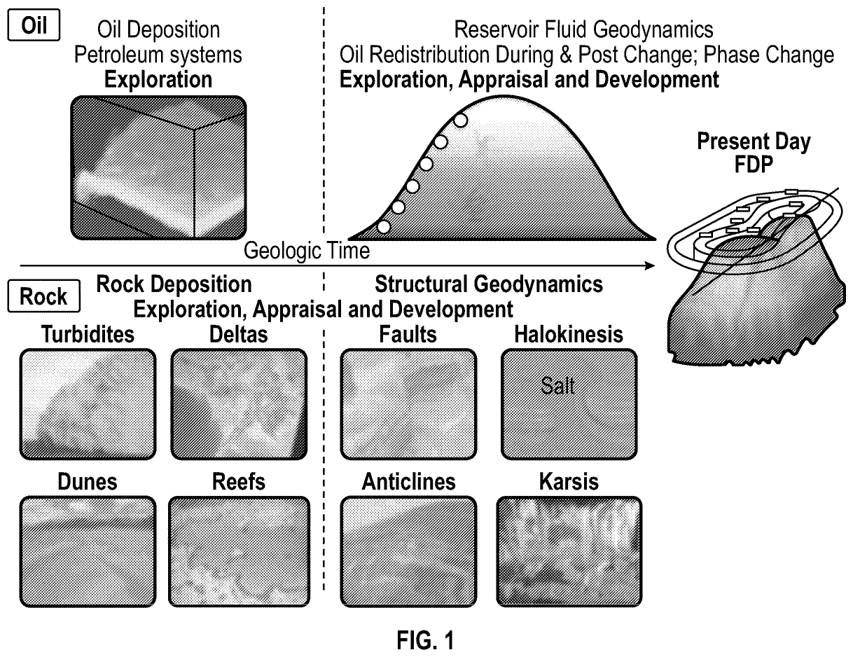

FIG. 2 depicts a graph showing monotonic generation and variation of charge maturity with a normal basin subsidence sequence, according to an embodiment of the disclosure.

FIG. 3 depicts an example of a scenario associated with incompatible charge and asphaltene colloidal instability up-structure, convection, and eventual accumulation with equilibration and bulk phase instability at the base.

FIG. 4 depicts various outcomes for the initial condition of gas charge into oil; all have been observed in RFG case studies. Wireline and other data acquisition can be designed to differentiate these different outcomes with their different requirements for field development plan (“FDP”).

FIG. 5 depicts an example of modeling an oil column with a hybrid RFG model for both the asphaltenes and solution gas. The top of the column is modeled with a diffusive gas flux and asphaltene expulsion (and migration). The bottom of the column is modeled with the outcome of quasi-equilibrium in both asphaltenes and solution gas. Here, quasi-equilibrium means spatially local equilibrium; however, it is not an actual equilibrium because with the passage of time, the column would change by diffusion etc., as defined systems said to be in equilibrium have no time dependence and no entropy generation (thus no flux). The success of this modeling is dramatic in that there are huge compositional variations that are all successfully accounted for. The impact on RFG of this understanding is critically important.

FIG. 6 depicts a reservoir containing an initially nonbiodegraded oil, followed by biodegradation at the oil water contact, hereinafter referred to as “OWC”. Alkanes diffuse to the OWC and are consumed by microbes. Thus, the oil column has a gradient of Peters-Moldowan rank=0 at the top of the column (no biodegradation) to PM rank=6 at the base of the column (severe biodegradation).

FIG. 7 depicts a spill-fill and continuous charging that can combined with biodegradation to give a sequence of reservoirs with increasing biodegradation for shallower reservoirs but with no gradient within a reservoir.

FIG. 8. Depicts a sequence of reservoirs where spill-fill dominated the extent of biodegradation levels across seven (7) reservoirs.

FIG. 9 depicts a gradient in Catcher is not too large and can be modeled to first order as a combination of spill-fill and diffusion at the OWC. A closer look at this reservoir; however, shows a significant biodegradation gradient at the top of Catcher as well as at the base. The origin of the gradient at the top of Catcher is due to the reduction of biodegradation of oil spilled out of the source reservoir Bittern due to subsidence and increasing temperature (present day T~80° C. so no more biodegradation).

FIG. 10 is a method of analyzing a geological structure in accordance with an example embodiment of the disclosure.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Aspects of the disclosure relate to modeling of geological structures. By way of definition, structures may be, for example, fluid structures or solid structures. The collection of processes that preclude equilibrium along with processes that give rise to equilibrium constitute the new technical discipline ‘reservoir fluid geodynamics’ (RFG) described herein.

With the discipline of RFG, it is possible to forward model oilfield reservoir fluids from inception to the present day. Nevertheless, forward modeling individual RFG processes can lead to multiple reservoir realizations because there is insufficient detail available on the process of trap filling, and a plethora of different detailed models in various disciplines have not been developed due to insufficient field data to develop and constrain such detailed models.

To illustrate such difficulties, one common occurrence of separate charges of gas and undersaturated oil may be considered in a single reservoir. In order to perform a precise, mechanistic forward model, many disciplines must be used simultaneously, including analysis of asphaltenes, nanocolloidal complexities and dynamics, diffusion, Boycott convection, asphaltene phase instability, and the complex interactions of all these processes. The understanding of these analyses, in an undetermined geologic structure of uncertain petrophysical complexity, is complex and attempts to conduct such analysis result in many errors. In short, such analysis concepts of forward modeling RFG seems daunting and perhaps practically impossible.

In contrast; however, the analysis of many reservoirs that have undergone RFG processes within an RFG perspective, such as those that have undergone separate undersaturated oil and gas charges, has enabled use of broadly simplifying concepts, making analysis readily achievable. Accordingly, many systematics have been observed in reservoirs that can be relied on to produce a “hybrid RFG model”. As will be understood, one observation is that reservoir fluids can undergo equilibration fairy rapidly across the reservoir. As will also be understood, such reservoirs may extend many kilometers. Some reservoirs are largely equilibrated even at the 100-kilometer length scale. Such equilibrium is not achieved by diffusion alone as equilibration by diffusion alone would have to extend for a trillion years. It is a logical conclusion; therefore, that equilibrium is achieved, at least in part, by other processes.

This means that convection necessarily is part of the RFG processes that lead to equilibrium. Convection over large length scales is many orders of magnitude faster than diffusion for mass transport. For convection to occur, however, a density inversion is required for the materials involved. The most common origin of density inversions are driven by thermal forces. In one example embodiment of thermal forces, convective cells are routinely observed in the process of boiling a specific trapped volume of water. In such an environment, the low-density hot water in the bottom volume rises as the cooler, denser water at the top of the column sinks. In example RFG reservoir studies, thermally driven density inversions are plausibly responsible for some of the observed convective mass transport. The evidence for thermally driven convection is the presence of significant quantities of primary biogenic solution gas at the base of equilibrated oil columns that are contained in very young reservoirs (e.g. middle Pliocene era). Nevertheless, the instability and migration of asphaltenes is likely to have a significant contribution from a complex process.

Another factor contributing to reaching equilibrium is nanocolloidal settling via Stokes falling and diffusion coupled with the Boycott effect for convection in unstable colloidal solutions. In some analysis, detailed mechanistic models are developed and tested against lab and field data. In embodiments, ultimately, these processes can be resolved and detailed, mechanistic models of RFG processes can be developed. In using a hybrid RFG model, embodiments exploit existing understanding of RFG processes to forward model reservoirs. The result observed in many reservoirs is fluid equilibration (in connected reservoirs) unless some other slow process precludes equilibrium. In embodiments, the final result is used as part of a hybrid RFG modeler. In embodiments of the hybrid RFG modeler, fast RFG processes are not modeled mechanistically, instead the final outcome of fast processes will be imposed in the different reservoir realizations. In addition, the process of phase transition of destabilized asphaltenes is very fast, this process too will be imposed as a final outcome. The location of the bulk phase transition can vary significantly depending on unavailable details of the process, so multiple outcomes will be considered for bulk phase transition. The likelihood of these different outcomes are analyzed in terms of controlling parameters. For example, (well) locations near charge points are much more likely to have complex mixing of charge fluids and up-structure bulk asphaltene phase transition, while locations far from charge points are more likely to have simpler outcomes associated with well-behaved vertically mixing.

Slow RFG processes such as diffusion can often be easily characterized due to massive impact on compositional spatial variation and can be captured in all phases of the process. Detailed mechanistic models, and sometimes analytic models, can be developed to account for these slow, well characterized processes. These mechanistic models for slow RFG processes represent the other major contribution to the hybrid RFG model.

### RFG Hybrid Model

In one example embodiment, slow processes affecting reservoir fluid composition are measured and modeled. These processes can take place over millions of years. In general, these processes leave a measurable impact on fluid composition. As such, the time dependent impact on fluid composition greatly improves the ability to develop modeling.

Diffusion is modeled with a detailed mechanistic accounting of the process. For example, diffusion over significant distance, which is slow on a geologic timeline (t>>million years) will be modeled with detailed solutions to the diffusion equation.

$$\frac{\partial C}{\partial t} = \frac{{\partial }^{2} C}{\partial {x}^{2}}$$

In some cases with appropriate boundary conditions, the analytic solution to the diffusion equation can be applied:

$$\frac{{C}_{0} - C ( x , t )}{{C}_{0}} = erf ( \frac{x}{2 \sqrt{Dt}} )$$

$$where$$

$$erf ( z ) = \frac{2}{π} {\int }_{0}^{z} ( {e}^{- {y}^{2}} ) \partial y .$$

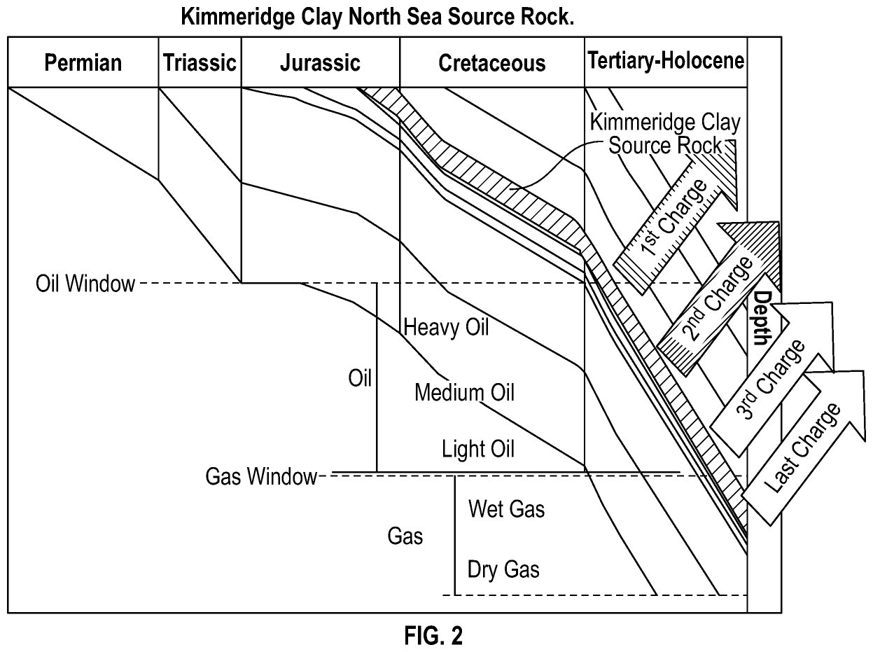

Charge history is another slow process evaluated by the hybrid RFG model. In embodiments, charge history is modeled with classic geochemical methods. Specifically, in the normal process of basin subsidence, the earliest charge from the source rock is the heaviest and with longer cooking times at greater temperatures, subsequent charges become lighter. This process is schematically shown of the Kimmeridge clay of the North Sea in FIG. 2, as one example embodiment of charge history observed from field conditions. These charges with their different compositions can density stack in the reservoir or can reflect their spatial distribution associated with charge. In particular, the latest charge fluids can reside near the charge point. At times, it is likely that these charges can enter a reservoir in the flank and can become stuck in a false attic created by a radial fault that does not extend to the OWC. Reservoirs that are likely in this scenario have been evaluated. If the latest charge is very recent, then the associated complex spatial distribution of charge can exist in present day.

### Fast Processes

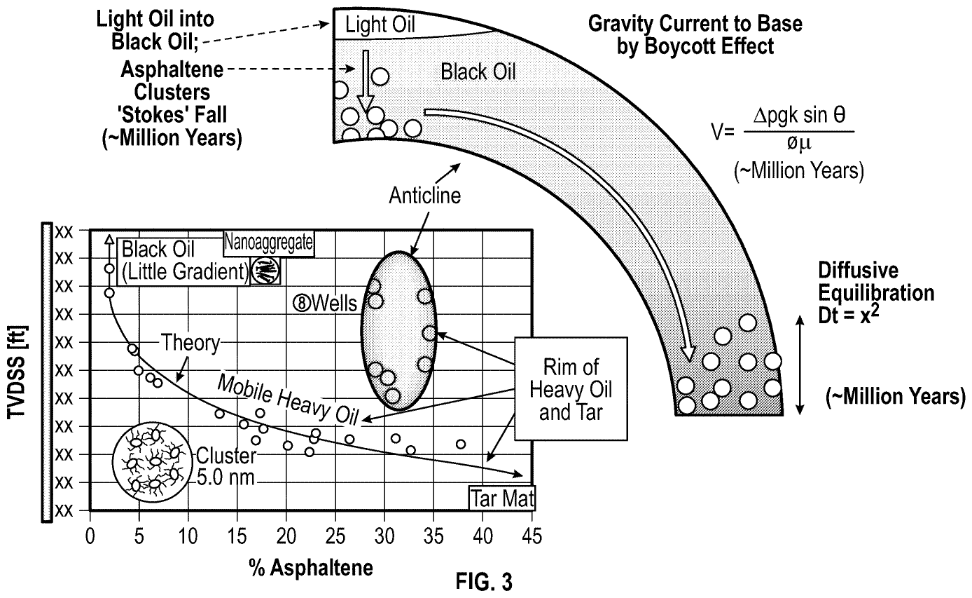

Embodiments of the hybrid RFG model also account for fast processes. In calculations, the fast processes in reservoirs are not modeled mechanistically. Instead, fast processes are modeled with their ultimate outcomes. Examples of fast processes include biodegradation at the OWC, local phase changes, Stokes falling, and localized diffusion. As will be understood, localized diffusion is diffusion that occurs over short distances as opposed to regular diffusion which is considered a slow process. FIG. 3 shows examples of several of these processes. Stokes falling of 5 nm clusters to the bottom of an interval (vertical section within a permeable zone) can take ~1 million years. The accumulation of asphaltenes at the base of the interval can give rise to convection by the Boycott effect. The flow velocity is parametric in several standard petrophysical and fluid properties such as dip angle, permeability, porosity, density contrast, and viscosity.

FIG. 3 shows one possible outcome for destabilized asphaltenes. Each component of the process is fast, in the order of one million years. These processes run concurrently to a degree. The consequence is that it is difficult to capture a reservoir in the middle of such a fast process and if there is some compositional imprint of a process, the compositional signatures are subtle and difficult to distinguish from a variety of other origins of small fluid complexities such as ponding of fluids, baffling, and local isolation. Consequently, any mechanistic model accounting for large scale asphaltene transport is under-constrained by measurement both in the temporal space and compositional space. Outcomes that depend on such modeling can be in error. In contrast, the outcomes of a significant transport of asphaltenes (or other components) to distant locations in the reservoir have clear and obvious impact in measurement and are easy to specify. In particular, the inexorable migration to equilibrium often yields a simplified equilibrated outcome to such fast RFG processes.

### Hybrid Model Utilization

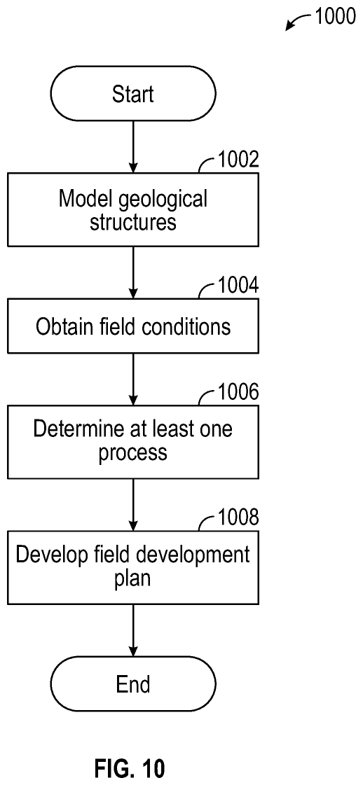

Utilization of the hybrid RFG model includes modeling of both fast and low RFG processes as illustrated in FIG. 10.

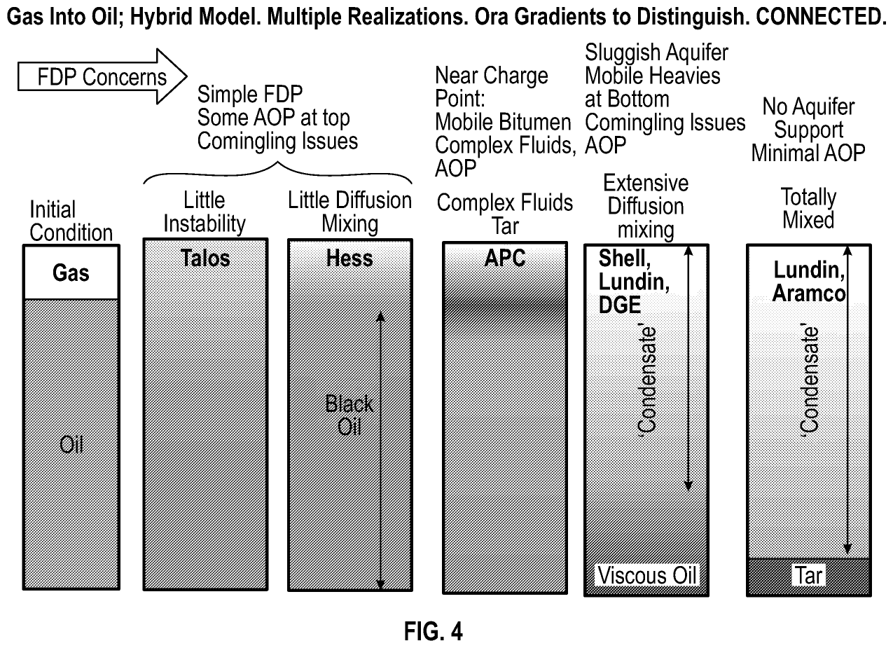

FIG. 4 shows various outcomes of a gas charge into oil. All of the various outcomes have been observed in RFG case studies. There are several outcomes depicted that have different implications on a field development plan (FDP) used to recover hydrocarbons present at a potential wellsite. Wireline and other data acquisition can be used with the objective of the wireline analysis to discern among the different outcomes and differentiate among different FDP requirements. In embodiments, the FDP accounts for Asphaltene onset pressure (“AOP”) to aid in the recovery of hydrocarbons present within the field.

Some field characteristics may be used by engineers in development of the FDP. For example, gas charge into oil is very easily observed. Frequently, the gas charged is primary biogenic with its clear carbon isotopic signature. In addition, the gas charge has an inordinate effect on solution gas. Various outcomes may be observed, associated both with fluid composition and bulk phase instability. Generally, once the asphaltenes deposit, the asphaltenes do not move in geologic time. There are dramatic effects on FDP for each of these outcomes. For some FDPs, these outcomes may be combined to deal with such conditions. Different reservoir outcomes might be successfully produced with the same FDP. By this process, FDP optimization could proceed. As will be understood, FDP optimization may occur according to different parameters. Such parameters may include reduced cost of economic production, speed of hydrocarbon recovery and minimization of field equipment.

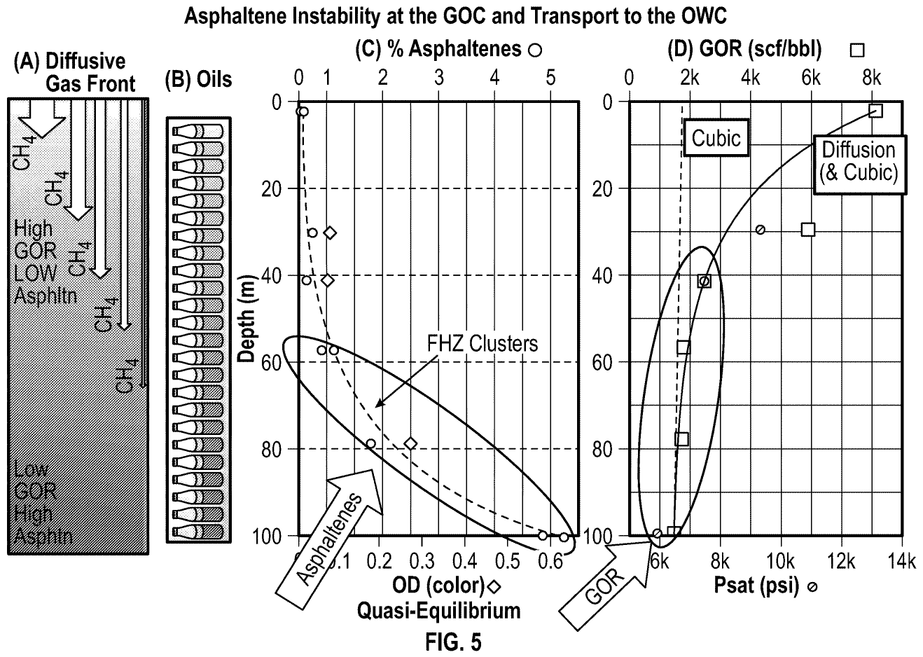

Referring to FIG. 5, one example of modeling an oil column with the hybrid RFG model for both the asphaltenes and solution gas is shown. The top of the column is modeled with a diffusive gas flux and asphaltene expulsion (and migration). The bottom of the column is modeled with the outcome of quasi-equilibrium in both asphaltenes and solution gas. The success of this modeling is dramatic in that there are huge compositional variations that are all successfully accounted for. The impact on RFG of this understanding is critically important.

Other incompatible charges, for example, a light oil into black oil may be more subtle and less easy to delineate than gas into oil because different oils often look similar to various analytical methods, especially in wireline logging. Nevertheless, these differences can also be uncovered by advanced analytical techniques and give outcomes similar to those shown in FIG. 4.

The process of biodegradation at the OWC is very fast. The question is how the hydrocarbon food arrives at the OWC. If diffusion over significant distance is required, then diffusive gradients are established that are slow in geologic time. The part of the oil column that diffusion has not impacted can be modeled with an equilibrium ‘outcome’ from fast RFG processes. FIG. 5 shows such an example.

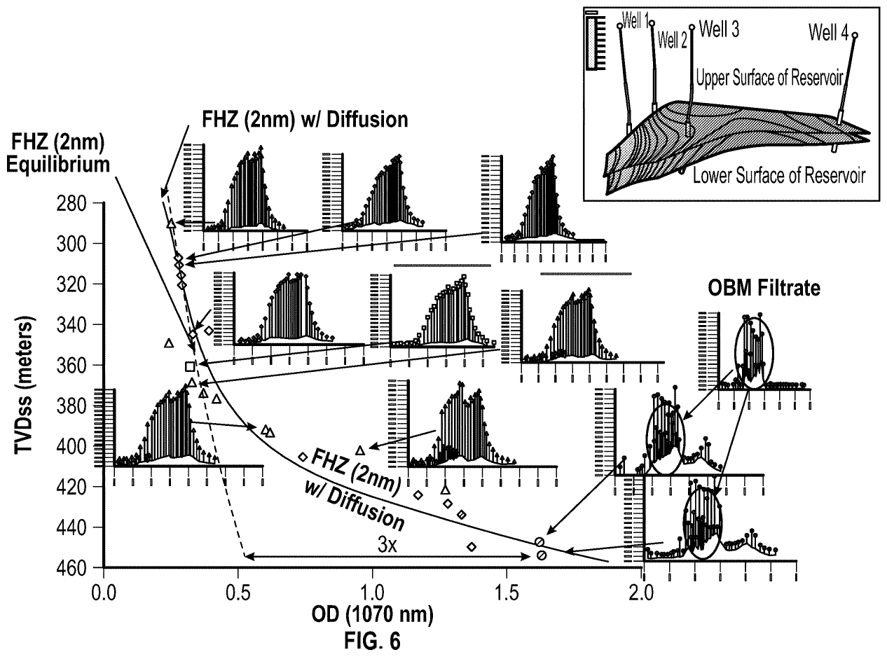

FIG. 6 shows a reservoir containing an initially nonbiodegraded oil, followed by biodegradation at the OWC. Alkanes diffuse to the OWC and are consumed by the microbes. Thus, the oil column has a gradient of Peters-Moldowan rank=0 at the top of the column (no biodegradation) to PM rank=6 at the base of the column.

In contrast to the slow process of diffusively mediated biodegradation shown in FIG. 6, a spill-fill sequence can yield uniform biodegradation in a series of reservoirs. Biodegradation is predominantly an in-reservoir process, as it does not occur (much) during migration. The deepest reservoir depicted in FIG. 6 shows a non-biodegraded charge. However, the reservoir is sufficiently cool (T<80° C.) that biodegradation can proceed in this deepest reservoir. Biodegradation increases oil density so the biodegraded oil stays at the OWC. In the case depicted, this thin layer of oil in the deepest reservoir is biodegraded to PM rank=2, then is spilled out to the middle reservoir. Here, the continuous charge causes this biodegraded oil to spill out of the deepest reservoir to the middle reservoir. This exposes new non-biodegraded oil in the deepest reservoir to the microbes, diffusion is not required. The microbes continuously biodegrade this freshly exposed oil, which is continuously spilled into the middle reservoir yielding a column of PM rank=2 in the middle reservoir. This shallower, colder reservoir also undergoes biodegradation at the OWC and this more heavily biodegraded oil then spill to the shallowest reservoir depicted, yielding a column of PM rank=4 in this shallowest reservoir. This process can continue to generate increasing differences in biodegradation between the deepest and shallowest reservoirs, yet with no gradient in a given reservoir.

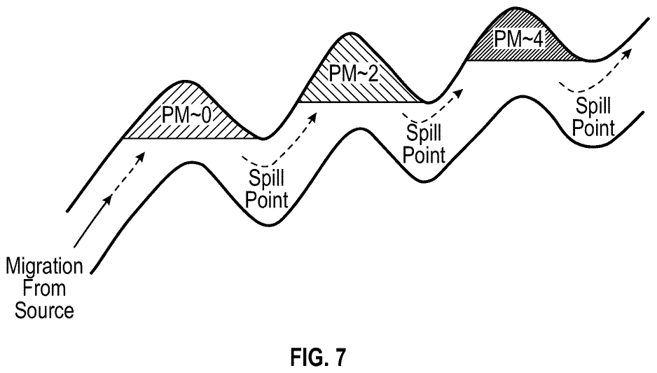

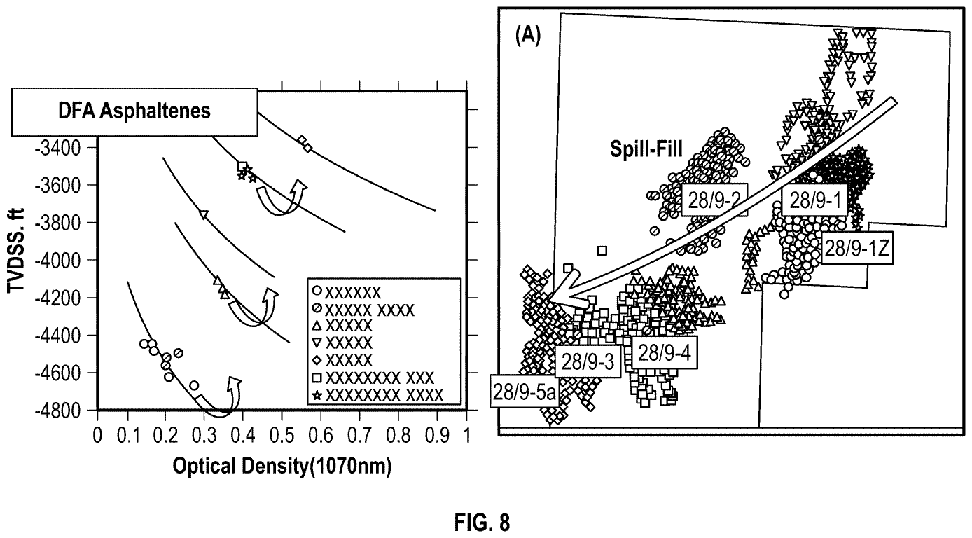

FIG. 8 shows a series of reservoirs that are close to those depicted in FIG. 7 as the endmember of spill-fill. In this case the deepest reservoir is the most attractive as that oil is least viscous.

The deepest reservoir, Catcher, in this series of reservoirs is being charged by Bittern which contains nonbiodegraded oil, but spills out PM Rank=2 biodegraded oil.

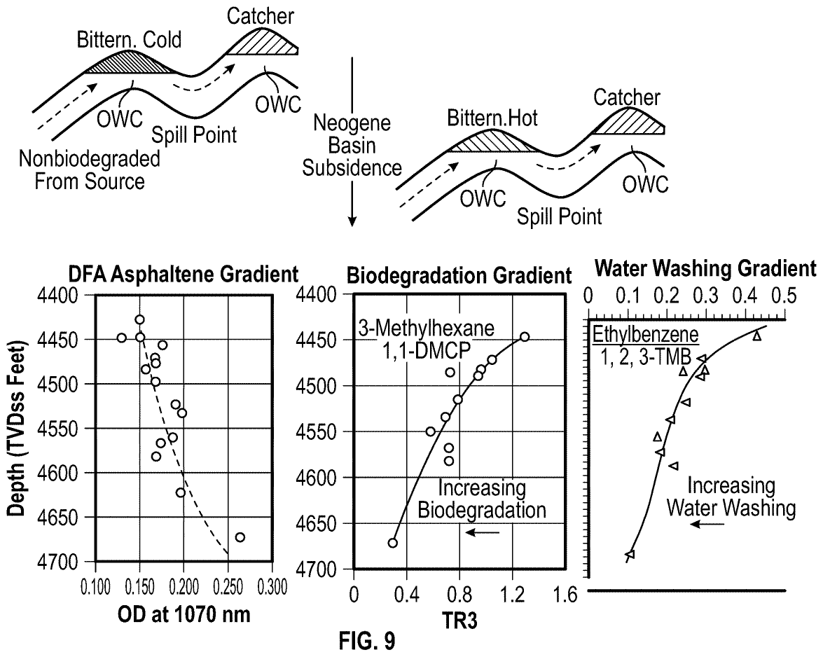

In FIG. 9, the gradient in Catcher is not too big and can be modeled to first order as a combination of spill-fill and diffusion at the OWC. However, a closer look at this reservoir shows a biodegradation at the top of Catcher as well as at the base. The origin of the gradient at the top of Catcher is due to the reduction of biodegradation of oil spill out of Bittern due to its subsidence and increasing temperature (present day T~80° C. so no more biodegradation).

The hybrid RFG model where fast processes are modeled with respect to outcome, especially equilibrated oil columns (or quasi-equilibrium), and slow processes are explicitly modeled mechanistically, is the best method to model reservoir fluids from charge to present day. The hybrid model can treat the most common processes in reservoirs including simple charges, multiple charges, incompatible charges, maturity variations and biodegradation.

For modeling purposes, it is important to identify a relevant time interval, identifying fast, intermediate and slow processes. As shown below, one million years is a time frame that can separate fast from slow processes. Nevertheless, it is understood that ongoing processes can be observable and measurable over timelines of 50 million years or more. One criterion for this objective is to identify the time required for mass transport from the top to the bottom of a vertical interval in a producing formation. Such intervals (gross pay in vertical wells) typically is on order of 100 meters. For diffusion, the mean square displacement x² for diffusion in time t in one dimension (diffusive mass transport in the reservoir and downwards) is given by 2Dt=x².

For a typical diffusion constant of 0.5×10−6 cm²/sec, this gives x~50 meters per one million years. Note that the displacement varies with the square root of time, thus at long times, diffusion becomes less effective as a mass transport mechanism.

For Stokes falling, Stokes velocity v is given by:

$$v = \frac{{gd}^{2} ( Δρ )}{18 η} ,$$

where g is the Earth's gravitation acceleration, d is the diameter of the particle, Δρ is the density difference between the particle and the suspending fluid, and n is the viscosity. For 5 nm asphaltene clusters in crude oil, Stokes velocity is v=150 meters/one million years.

These displacement processes of diffusion and Stokes falling of nanoparticles, over an interval of one million years, are considered slow.

In contrast, natural convection velocity v driven by a density inversion Δρ is generally fast. The relevant equation is:

$$v = \frac{Δρ gk sin θ}{∅η}$$

where k is permeability, θ is the dip angle, Ø is porosity (g, η are given above). For a dip angle of 30°, and a milligram density inversion along with typical formation parameters, the convective velocity is v=60 km/one million years.

Thus, if there is a density inversion, then convective velocities can be huge in comparison to slow processes of diffusion and Stokes falling of nanoparticles.

Two mechanisms that can induce a density inversion are thermal gradients and asphaltene instability and downward accumulation ahead of a diffusive gas front from above.

Processes of an intermediate rate can be identified that do not fit well in fast or slow categories. Such processes are defined to have moderate mass transport rates in reservoirs. An example is when there is diffusion-induced asphaltene instability and downward migration and when and when the diffusive displacement is essentially vertical (as opposed to along the formation of a reservoir with a small dip angle). In such cases of vertical diffusion, then asphaltene destabilization and migration can be moderate in magnitude, and not too small to ignore as in cases with small dip angle.

Within the context of the modeling herein, intermediate processes are to be modeled in part as a mechanistic and in part outcome, thus with the Hybrid approach.

Referring to FIG. 10, an example method 1000 of the disclosure is provided. The method may evaluate geological structures. Geological structures may include both fluid structures and solid structures. Solids may be defined as rock, soil or combinations of rock and soil. The method 1000 may include analysis of slow processes. Such slow processes may include diffusion and charge history. At 1002, the method 1000 continues for modeling geological structures using at least one of diffusion and charge history. As will be understood, either diffusion or charge history (or both at the same time) may be modeled. The method may also continue, at 1004, with obtaining a final outcome of field conditions. The obtaining of the final outcome of field conditions may be achieved by obtaining field conditions of the geological structures. The method may further comprise, at 1006, using the field conditions of the geological structures, determining at least one process of biodegradation, local phase change, Stokes falling and localized diffusion for the system. The method may also further comprise determining a field development plan based upon the method at 1008. In embodiments, the field development plan takes into account the at least one process of biodegradation, local phase change, Stokes falling and localized diffusion.

As will be understood, method steps for completion may be stored in the random access memory, read only memory, flash memory, computer hard disk drives, compact disks, floppy disks and solid state drives. Embodiments of the disclosure may be incorporated into a non-volatile memory for storage and execution by a computing device. Such computing devices may include personal computers, computer servers, cloud computing devices or other types of devices.

Embodiments of the disclosure are cited. In one non-limiting embodiment, a method of analyzing a geological stratum including geological structures including both fluids and solids. The method may comprise modeling the geological structures using at least one of diffusion and charge history. The method may also comprise obtaining a final outcome of field conditions. The method may also comprise using such field conditions, determining a presence of at least one fast process in the geological stratum, wherein the fast process is at least one process of biodegradation, local phase change, nanocolloidal settling, spill-fill and localized diffusion.

In another example embodiment, the method may further comprise determining a field development plan based on the method of analyzing the geological stratum.

In another example embodiment, the method may be performed wherein the obtaining the final outcome of field conditions includes performing a wireline analysis of the geological structures.

In another example embodiment, the method may be performed, wherein the fluids include at least of a hydrocarbon-based gas, a hydrocarbon-based liquid, a supercritical hydrocarbon-based phase and a unsaturated hydrocarbon phase

In another example embodiment, the method may be performed wherein the modeling the geological structures using the at least one of diffusion and charge history includes applying a modeling constraint.

In another example embodiment, the method may be performed wherein the nanocolloidal setting occurs through Stokes falling.

In another example embodiment, the method may be performed wherein the diffusion is coupled with the Boycott effect.

In another example embodiment, the method may be performed wherein the field development plan accounts for Asphaltene onset pressure.

In another example embodiment, the method may be performed wherein the field development plan is optimized for at least one of economic income and cashflow.

In another example embodiment, an object of manufacture configured to store a set of instructions configured to be performed on a computer, the object of manufacture having a non-volatile memory, the set of instructions comprising a metho is disclosed. The method steps of the method may comprise modeling the geological structures using at least one of diffusion and charge history and obtaining a final outcome of field conditions. The method may also comprise using such field conditions, determining a presence of at least one fast process in the geological stratum, wherein the fast process is at least one process of biodegradation, local phase change, nanocolloidal settling and localized diffusion.

In another example embodiment, the article of manufacture may be configured wherein the article of manufacture is one of a universal serial bus device, a compact disc and a solid-state memory device.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. It is also contemplated that various combinations or sub-combinations of the specific features and aspects of the embodiments described may be made and still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method of analyzing a geological stratum including geological structures including both fluids and solids, comprising:
modeling the geological structures using at least one of diffusion and charge history;
obtaining a final outcome of field conditions, and
using such field conditions, determining a presence of at least one fast process in the geological stratum, wherein the fast process is at least one process of biodegradation, local phase change, nanocolloidal settling, spill-fill, and localized diffusion.

2. The method according to claim 1, further comprising:
determining a field development plan based on the method of analyzing the geological stratum.

3. The method according to claim 1, wherein the obtaining the final outcome of field conditions includes performing a wireline analysis of the geological structures.

4. The method according to claim 1, wherein the fluids include at least one of a hydrocarbon-based gas, a hydrocarbon-based liquid, a supercritical hydrocarbon based phase and a unsaturated hydrocarbon phase.

5. The method according to claim 1, wherein the modeling the geological structures using the at least one of diffusion and charge history includes applying a modeling constraint.

6. The method according to claim 1, wherein the nanocolloidal setting occurs through Stokes falling.

7. The method according to claim 1, wherein the diffusion is coupled with the Boycott effect.

8. The method according to claim 2, wherein the field development plan accounts for Asphaltene onset pressure.

9. The method according to claim 2, wherein the field development plan is optimized for at least one of economic income and cashflow.

10. An object of manufacture configured to store a set of instructions configured to be performed on a computer, the object of manufacture having a non-volatile memory, the set of instructions comprising a method with method steps comprising:
modeling the geological structures using at least one of diffusion and charge history;
obtaining a final outcome of field conditions, and
using such field conditions, determining a presence of at least one fast process in the geological stratum, wherein the fast process is at least one process of biodegradation, local phase change, nanocolloidal settling and localized diffusion.

11. The article of manufacture according to claim 10, wherein the article of manufacture is one of a universal serial bus device, a compact disc and a solid state memory device.
